(19) United States
(12) Patent Application Publication
(10) Pub. No.: US 2025/0300721 A1
(43) Pub. Date: Sep. 25, 2025

(54) SYSTEMS, METHODS, AND DEVICES FOR WIRELESS RELAYS

(71) Applicant: Cypress Semiconductor Corporation, San Jose, CA (US)

(72) Inventors: Rohit GUPTA, New Delhi (IN); Venkata Sesha Sai Teja Mungamuri, Hyderabad (IN)

(73) Assignee: Cypress Semiconductor Corporation, San Jose, CA (US)

(21) Appl. No.: 18/609,629

(22) Filed: Mar. 19, 2024

(51) Int. Cl. H04B 7/185

(52) U.S. Cl. CPC H04B 7/18513

(57) ABSTRACT

Systems, methods, and devices include wireless relays for wireless communication. Methods include receiving an input via a first wireless connection at a wireless device, the input comprising a first data packet compatible with a first wireless protocol, and identifying a second wireless connection compatible with a second wireless protocol based on the received input. Methods further include generating, using a dual-mode controller of the wireless device, an output based, at least in part, on the received input and the second wireless protocol, the output comprising a second data packet compatible with the second wireless protocol, and transmitting the output via the second wireless connection using the second wireless protocol.

### TECHNICAL FIELD

This disclosure relates to wireless devices, and more specifically, to enhancement of relaying signals between such wireless devices.

### BACKGROUND

Wireless devices may include various components configured to facilitate communications in accordance with one or more wireless protocols. For example, a wireless device may have a transceiver and associated processing logic configured to send and receive data in accordance with a wireless standard specified by a wireless protocol. Wireless devices may be in communication with various other wireless devices, and thus may support wireless connections with multiple wireless devices at a time. Moreover, multiple wireless protocols as well as different versions of a particular wireless protocol may exist thus preventing some wireless devices from communicating with each other. Conventional techniques remain limited because they are not able to efficiently allow communications between wireless devices with such disparate wireless protocols.

### BRIEF DESCRIPTION OF THE DRAWINGS

FIG. 1 illustrates an example of a wireless relay system, configured in accordance with some embodiments.

FIG. 2 illustrates another example of a wireless relay system, configured in accordance with some embodiments.

FIG. 3 illustrates an example of a wireless device, configured in accordance with some embodiments.

FIG. 4 illustrates an example of a wireless relay method, performed in accordance with some embodiments.

FIG. 5 illustrates another example of a wireless relay method, performed in accordance with some embodiments.

FIG. 6 illustrates an example of a wireless mapping method, performed in accordance with some embodiments.

### DETAILED DESCRIPTION

In the following description, numerous specific details are set forth in order to provide a thorough understanding of the presented concepts. The presented concepts may be practiced without some or all of these specific details. In other instances, well known process operations have not been described in detail so as not to unnecessarily obscure the described concepts. While some concepts will be described in conjunction with the specific examples, it will be understood that these examples are not intended to be limiting.

Wireless devices may communicate with each other by transmitting data in accordance with various wireless protocols. In a wireless environment, such as an automobile cabin, multiple different wireless protocols may be used by various different wireless devices included in the wireless environment. For example, a first wireless device, such as a smartphone, may be using a classic version of Bluetooth for wireless communication, and a second wireless device, such as a headset, may be using Bluetooth Low Energy for wireless communication. Conventional techniques for facilitating communication between such wireless devices using different versions of a wireless protocol remain limited because they are not able to facilitate communication between the two in an efficient manner.

Embodiments disclosed herein provide wireless devices that may be configure to facilitate communication between wireless devices using different wireless protocols, and more specifically, different versions of a wireless protocol. As will be discussed in greater detail below, a wireless device may be configured as a wireless relay that is capable relaying communications between such wireless devices, and thus providing interoperability between such wireless devices using different versions of wireless protocols. As will also be discussed in greater detail below, such relay capabilities may be implemented via a dual-mode controller, and may be implemented such that use of an application layer and host layer of the wireless device are not needed for relay operations. In this way, embodiments disclosed herein provide improved efficiency and efficacy of wireless relay operations.

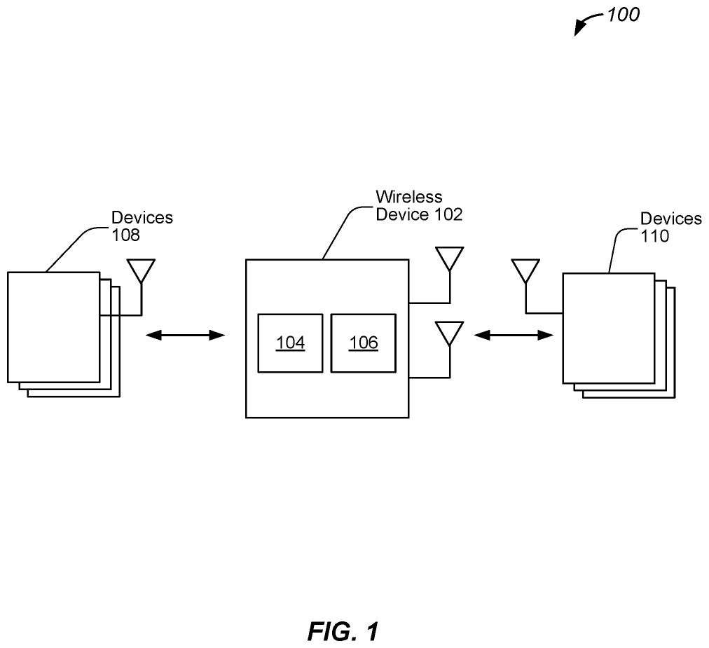

FIG. 1 illustrates an example of a wireless relay system, configured in accordance with some embodiments. Accordingly, a system, such as system 100, may include wireless devices that are used for wireless communications, and are also configured to be able to perform wireless relay operations as disclosed herein. Accordingly, as will be discussed in greater detail below, wireless devices included in system 100 may be configured to transparently relay data between devices even when different communications protocols are used. Moreover, such relay operations may be managed within the baseband controller of a wireless protocol stack.

In various embodiments, system 100 may include wireless device 102 which may be a wireless communications device. As discussed above, such wireless devices may be compatible with one or more wireless protocols, such as a Bluetooth protocol. Accordingly, wireless device 102 includes a transceiver, such as transceiver 106. As will be discussed in greater detail below, processing devices and associated transceivers may be configured to establish communications connections with other devices, and transmit data in the form of data packets via such communications connections and in accordance with a wireless protocol.

As discussed above, transceiver 106 may be a Bluetooth transceiver coupled to a communications medium, such as an antenna. In some embodiments, the Bluetooth protocol may be a Bluetooth classic protocol, or it may be a Bluetooth Low Energy (BLE) protocol. As will be discussed in greater detail below, one or more other components of wireless device, such as processing device 104, may be configured to include a dual-mode controller that includes a controller relay. Accordingly, processing device 104 is configured to perform translation and relay operations to transparently facilitate communication between different wireless protocols.

In various embodiments, wireless device 102 may be included in a wireless environment, such as an automobile cabin. Accordingly, wireless device 102 may be included in a head unit of an infotainment system, and may be configured to communicate with various other wireless devices within an automobile, such as devices 108 and devices 110. Accordingly, devices 108 and devices 110 may also be wireless devices configured to be compatible with wireless protocols. It will be appreciated that wireless device 102, devices 108, and devices 110 may be any suitable types of devices, such as those found in other vehicles as well as smarthome environments.

In some embodiments, devices 108 may be compatible with a first wireless protocol, and devices 110 may be compatible with a second wireless protocol. For example, devices 108 may be compatible with a Bluetooth classic protocol, and devices 110 may be compatible with a BLE protocol. As will be discussed in greater detail below, wireless device 102 may be configured to facilitate communication between devices 108 and devices 110. More specifically, wireless device 102 may operate as a relay, and may be configured to perform translation and relay operations to facilitate such communication.

In one example, devices 108 may include a smartphone that is streaming audio data via a Bluetooth classic connection with wireless device 102. Wireless device 102 may perform relay operations to convert the streamed audio data to a BLE protocol, and may then transmit that converted audio data to devices 110, which may include wireless earphones. In this example, communication is facilitated between devices 108 and devices 110 which use different wireless protocols, but are unaware of the difference.

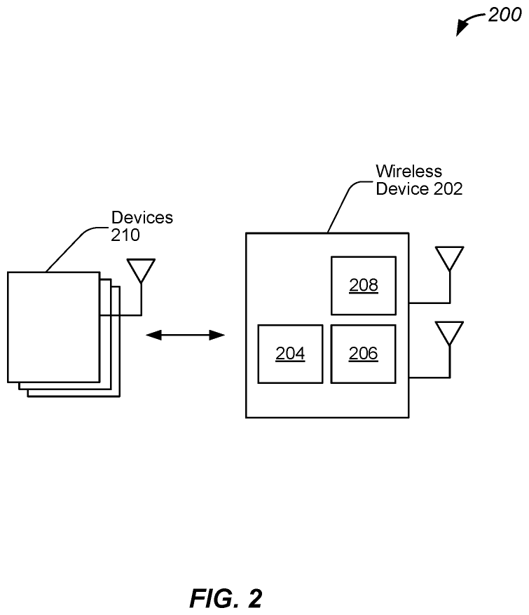

FIG. 2 illustrates another example of a wireless relay system, configured in accordance with some embodiments. As similarly discussed above, a system, such as system 200, may include wireless devices that are used for wireless communications, and are also configured to be able to perform wireless relay operations as disclosed herein. In this example, relay operations may be performed for a wireless device, such as wireless device 202. In this way, wireless device 202 and additional devices, such as devices 210, may be compatible with different wireless protocols, but relay operations may be performed to facilitate communication between the two.

More specifically, as similar discussed above, wireless device 202 may include transceiver 206, which may be configured to be compatible with a first wireless protocol, such as a Bluetooth classic protocol. Wireless device 202 may also include processing device 204 which is configured to include processing logic associated with transceiver 206 and is also configured to be compatible with the first wireless protocol. In various embodiments, wireless device 202 additionally includes controller 208 which may be a processing device that is configured to perform translation and relay operations to facilitate communication with devices 210, which may be configured to be compatible with a second wireless protocol, such as a BLE protocol. In this way, controller 208 may be integrated within wireless device 202 to enable communication between devices 210 and wireless device 202. It will be appreciated that controller 208 may be implemented in a separate processing device than processing device 204, or controller 208 may be implemented within processing device 204 as a dual-mode controller in a baseband layer.

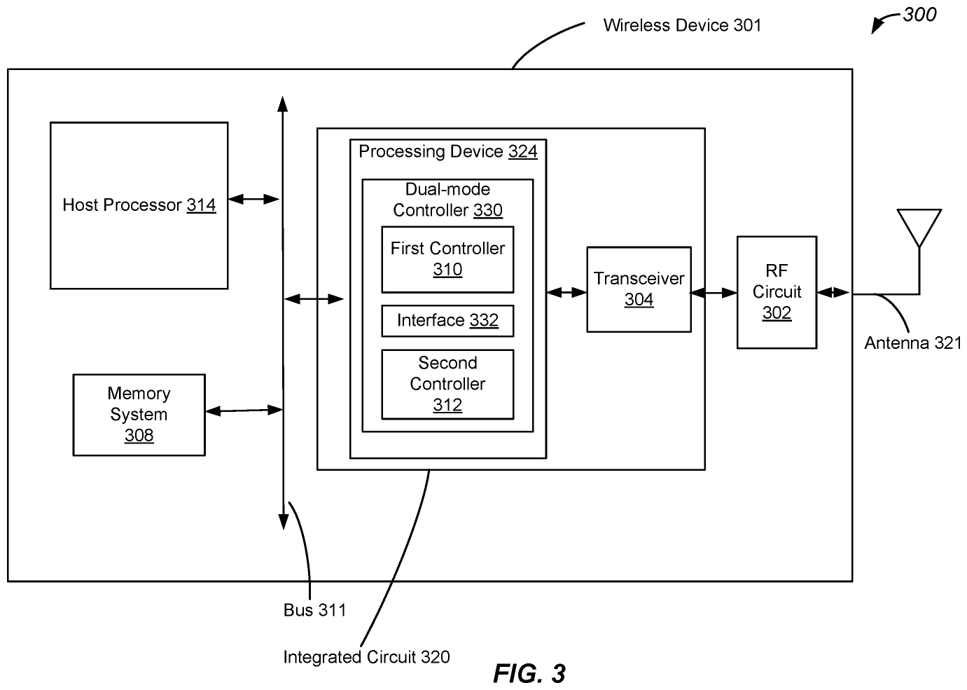

FIG. 3 illustrates an example of a wireless device, configured in accordance with some embodiments. More specifically, FIG. 3 illustrates an example of a system, such as system 300, that includes wireless device 301. It will be appreciated that wireless device 301 may be one of any of the wireless devices discussed above with reference to FIG. 1, such as wireless device 102 and wireless device 202.

In various embodiments, wireless device 301 includes one or more transceivers, such as transceiver 304. In one example, transceiver 304 is configured to transmit and receive signals using a communications medium that may include antenna 321. As noted above, transceiver 304 may be a Bluetooth transceiver. Accordingly, transceiver 304 may be compatible with a Bluetooth communications protocol. In various embodiments, transceiver 304 includes a modulator and demodulator as well as one or more buffers and filters, that are configured to generate and receive signals via antenna 321. While various embodiments are described with reference to Bluetooth protocols, it will be appreciated that any suitable protocol may be used.

In various embodiments, system 300 further includes processing device 324 which may include logic implemented using processing elements and/or one or more processor cores. In various embodiments, such logic may be implemented via firmware. As will be discussed in greater detail below, processing device 324 comprises processing elements that are configured to implement relay operations disclosed herein. Moreover, processing device 324 includes one or more components configured to implement a Bluetooth stack that is used to support the Bluetooth protocol. Accordingly, processing device 324 may include a processor core block configured to implement a driver, such as a Bluetooth driver. Processing device 324 may further include a digital signal processor (DSP) core block which may be configured to include microcode.

In various embodiments, processing device 324 comprises one or more processor cores configured to implement specific portions of a wireless protocol interface. For example, a Bluetooth protocol may be implemented using a Bluetooth stack in which software is implemented as a stack of layers, and such layers are configured to compartmentalize specific functions utilized to implement the Bluetooth communications protocol. For example, an application layer may be implemented to manage application profiles and services. Moreover, a host layer may be implemented include a host stack for a Bluetooth network encapsulation protocol, radio frequency communication, service discovery protocol, as well as various other high level data layers.

In various embodiments, a controller layer is configured to implement a controller stack that includes a link management protocol, a host controller interface, a link layer which may be a low energy link layer, as well as various other timing critical layers and the baseband layer. As shown in FIG. 3, dual-mode controller 330 may include first controller 310 and second controller 312, as well as interface 332 that is configured to provide a communications interface between them. Accordingly, first controller 310 may be compatible with a first wireless protocol, such as Bluetooth classic protocol, and may include an encoder and decoder configured based on the first wireless protocol. Moreover, second controller 312 may be compatible with a second wireless protocol, such as a BLE protocol, and may include an encoder and decoder configured based on the second wireless protocol. Moreover, as will be discussed in greater detail below, dual-mode controller 330 may be configured to perform mapping and translation operations to facilitate communication between them.

System 300 further includes radio frequency (RF) circuit 302 which is coupled to antenna 321. In various embodiments, RF circuit 302 may include various components such as an RF switch, a diplexer, and a filter. While FIG. 3 illustrates system 300 as having one antenna, it will be appreciated that system 300 may have a two antennas, or any suitable number of antennas. Accordingly, RF circuit 302 may be configured to select an antenna for transmission/reception, and may be configured to provide coupling between the selected antenna, such as antenna 321, and other components of system 300 via a bus, such as bus 311. While one RF circuit is shown, it will be appreciated that wireless device 301 may include multiple RF circuits. Accordingly, each of multiple antennas may have its own RF circuit.

System 300 includes memory system 308 which is configured to store one or more data values associated with translation and relay operations discussed above and in greater detail below. Accordingly, memory system 308 includes storage device, which may be a non-volatile random access memory (NVRAM) configured to store such data values, and may also include a cache that is configured to provide a local cache. In various embodiments, system 300 further includes host processor 314 which is configured to implement processing operations implemented by system 300.

It will be appreciated that one or more of the above-described components may be implemented on a single chip, or on different chips. For example, transceiver 304 and processing device 324 may be implemented on the same integrated circuit chip, such as integrated circuit chip 320. In another example, transceiver 304 and processing device 324 may each be implemented on their own chip, and thus may be disposed separately as a multi-chip module or on a common substrate such as a printed circuit board (PCB). It will also be appreciated that components of system 300 may be implemented in the context of a low energy device, a smart device, or a vehicle such as an automobile. Accordingly, some components, such as integrated chip 320, may be implemented in a first location, while other components, such as antenna 321, may be implemented in second location, and coupling between the two may be implemented via a coupler such as RF circuit 302.

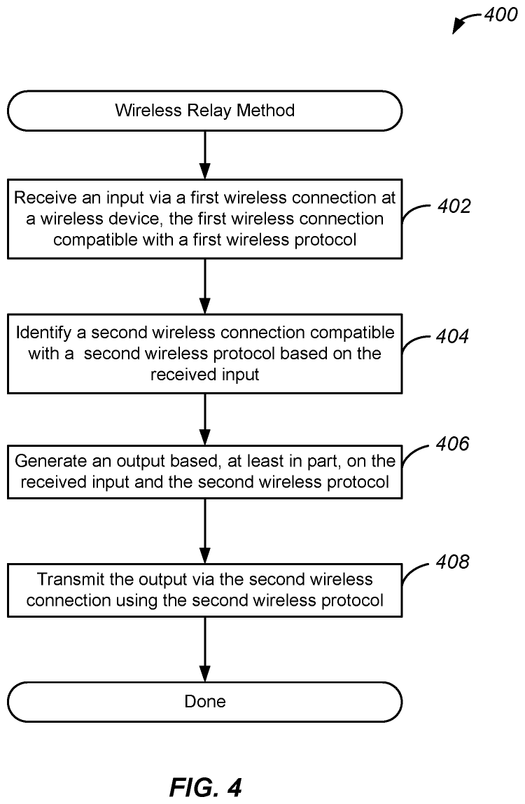

FIG. 4 illustrates an example of a wireless relay method, performed in accordance with some embodiments. Accordingly, a method, such as method 400, may be performed to implement relay operations as disclosed herein. As will be discussed in greater detail below, wireless devices may transparently relay data between devices even when different communications protocols are used. Moreover, such relay operations may be managed within the controller layer of a wireless protocol stack.

Method 400 may perform operation 402 during which an input may be received via a first wireless connection at a first wireless device, where the first wireless connection is compatible with a first wireless protocol. In various embodiments, the input may be a data packet received via the first wireless connection. In one example, the data packet may be received from a second wireless device that uses the first wireless connection to communicate with the first wireless device.

Method 400 may perform operation 404 during which a second wireless connection may be identified based on the received input. In various embodiments, the second wireless connection is compatible with a second wireless protocol. As similarly discussed above, the second wireless protocol may be different than the first wireless protocol. Moreover, the second wireless connection may be used by the first wireless device to communicate with a third wireless device. As will be discussed in greater detail below, a designated mapping may be used to map the first wireless connection to the second wireless connection.

Method 400 may perform operation 406 during which an output may be generated based, at least in part, on the received input and the second wireless protocol. In various embodiments, the output may be a data packet that is compatible with the second wireless protocol. Accordingly, the input data packet may be translated to the second wireless protocol to generate an output data packet. As will be discussed in greater detail below, such mapping and translation operations may be performed by a dual-mode controller of the first wireless device.

Method 400 may perform operation 408 during which the output may be transmitted via the second wireless connection using the second wireless protocol. Accordingly, the data packet generated during operation 406 may be transmitted to the third wireless device in accordance with the second wireless protocol. In this way, the first wireless device may operate as a relay between the second wireless device and the third wireless device, and may have components of a controller layer, such as a dual-mode controller, configured to perform such relay operations.

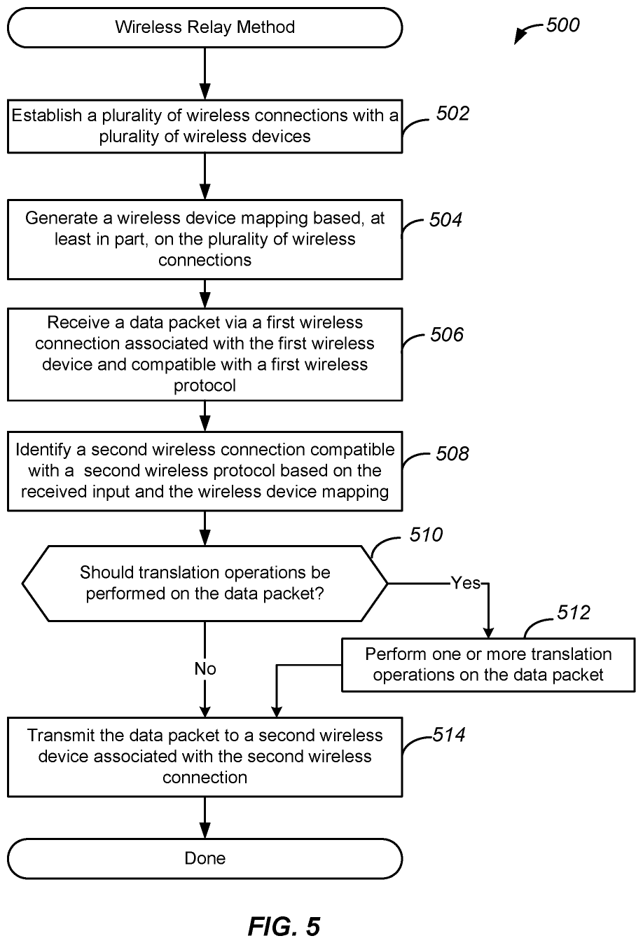

FIG. 5 illustrates another example of a wireless relay method, performed in accordance with some embodiments. Accordingly, a method, such as method 500, may be performed to implement relay operations as disclosed herein. As will be discussed in greater detail below, mapping information and wireless connection information may be used to facilitate relay operations between different wireless devices even when they may be using different wireless protocols.

Method 500 may perform operation 502 during which a plurality of wireless connections may be established with a plurality of wireless devices. In various embodiments, the wireless devices may be various different wireless devices within a wireless environment, and multiple wireless devices may communicate with a central wireless device. Moreover, wireless connections may be established during a connection discovery process. In one example, multiple wireless devices may establish wireless connections with a central device that may be included in a head unit of an infotainment system.

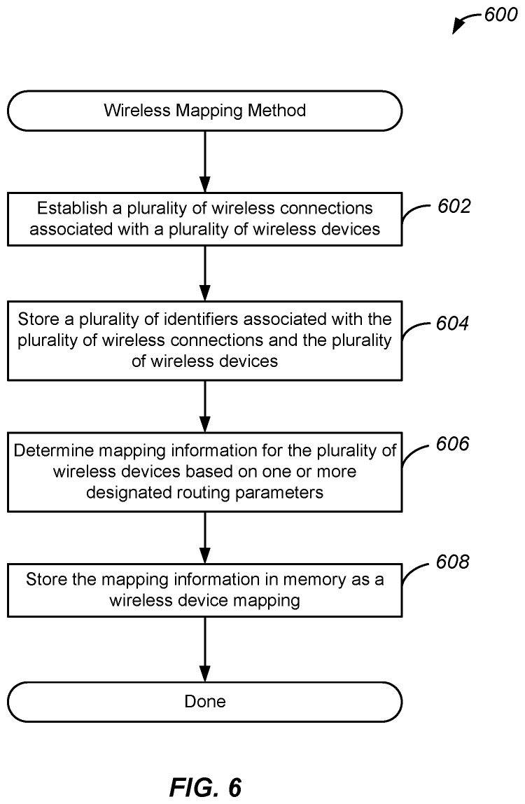

Method 500 may perform operation 504 during which a wireless device mapping may be generated based, at least in part, on the plurality of wireless connections. As will be discussed in greater detail below with reference to FIG. 6, the wireless device mapping may be a data structure configured to represent relationships and associations between wireless devices and their associated wireless connections. Such a wireless device mapping may be generated based, at least in part, on routing information specifying how data should be routed between wireless devices.

Method 500 may perform operation 506 during which a data packet may be received via a first wireless connection associated with the first wireless device and compatible with a first wireless protocol. In one example, the data packet may be an audio data packet including audio data streamed from the first wireless device which, in this example, may be a smartphone or other audio streaming device. Moreover, the first wireless protocol may be a Bluetooth classic protocol.

Method 500 may perform operation 508 during which a second wireless connection may be identified based on the received input and the wireless device mapping. Accordingly, the mapping may be configured to identify the second wireless connection based on the identifiers associated with the first wireless connection. Thus, in response to receiving the data packet and first wireless connection information, the second wireless connection as well as a second wireless protocol may be identified.

As similarly discussed above, the use of the wireless device mapping may be performed by a dual-mode controller implemented in a controller layer of the central wireless device. In this way, mapping of the wireless connections happens entirely within the controller layer, and invocation of the application layer and host layers is not needed.

Method 500 may perform operation 510 during which it may be determined if translation operations should be performed. In various embodiments, such a determination may be made based on a determination of whether or not the first wireless protocol and the second wireless protocol are the same or if they are different. In various embodiments, the wireless device mapping includes wireless connection information for the wireless connections associated with the mapping. More specifically, wireless connection information may have been stored that identifies a wireless protocol associated with each wireless connection, and such wireless connection information may be compared to determine if the wireless protocol of an input wireless connection is the same or different from an output wireless connection.

In various embodiments, an interface may also be a command interface which is configured to receive translation parameters from a host or an application. Accordingly, such translation parameters may specify operations to be performed in a translation process, and when particular translation operations should be implemented. For example, the translation parameters may include a mapping of wireless protocol parameters to translation operations. Such a mapping may have been generated by an entity, such as a manufacturer, in accordance with a wireless protocol. If the wireless protocols are the same or are compatible, it may be determined that no translation operations are needed and method 500 may proceed to operation 514 discussed in greater detail below.

Accordingly, if it is determined that wireless protocols are different and/or incompatible, it may be determined that translation operations should be performed, and method 500 may perform operation 512 during which one or more translation operations may be performed on the data packet received during operation 506. In various embodiments, a dual-mode controller may include both an encoder and decoder for each of the first wireless protocol and the second wireless protocol. Accordingly, the translation operations may be performed to decode the data of the received data packet from the first wireless protocol, and encode the data within a new data packet in accordance with the second wireless protocol.

In one example, the first wireless connection may include audio data streamed from a smartphone using a Bluetooth classic protocol. Based on routing information that may have been provided by, for example, the mapping information may have been generated identifying a second wireless connection that is a BLE connection used by a wireless headset. In this example, the audio data may be received at the central device, and a dual-mode controller may perform decoding of the audio data from a Bluetooth classic format specified by the Bluetooth classic protocol. The dual-mode controller may then encode the decoded data into the a BLE format specified by the BLE protocol. As similarly discussed above, the encoding and decoding process may be performed within a controller layer, and does not use an application layer or a host layer of the Bluetooth stack. Thus, the output generated during operation 512 may be a transcoded data packet compatible with the second wireless connection.

Method 500 may perform operation 514 during which a data packet may be transmitted to a second wireless device associated with the second wireless connection. As similarly discussed above, the data packet may include the data that was originally received via the first data packet. For example, where streamed audio data was received from a streaming device, the audio data may be transmitted to the second wireless device, which may be a headset, that may then play the audio data.

In an example where no translation operations were performed, the data packet may be passed through the central wireless device and forwarded to the second wireless device. In an example where translation operations were performed, the new data packet generated by the transcoding process is forwarded.

FIG. 6 illustrates an example of a wireless mapping method, performed in accordance with some embodiments. As discussed above, a designated mapping may be used, at least in part, to manage relay operations performed by wireless devices. Accordingly, a method, such as method 600, may be performed to generate such a designated mapping.

Method 600 may perform operation 602 during which a plurality of wireless connections may be established with a plurality of wireless devices. As similarly discussed above, the wireless devices may be various different wireless devices within a wireless environment that communicate with a central wireless device. Moreover, wireless connections may be established during a connection discovery process.

Method 600 may perform operation 604 during which a plurality of identifiers associated with the plurality of wireless connections and the plurality of wireless devices may be stored. Accordingly, the central device may store and maintain wireless connection information identifying the connections established during the connection discovery process. The wireless connection information may include data such as a device identifier for the wireless device that was connected to, and wireless channel information or other wireless connection information. In one example, the wireless channels may be numbered, and the number may be stored as an identifier. In various embodiments, the wireless connection information may also store wireless protocol information identifying a wireless protocol associated with the wireless connection as well as various other channel information, such as signal quality metrics. In one example, the type of wireless protocol may be determined based on a component of a received message, such as a sync request.

Method 600 may perform operation 606 during which mapping information for the plurality of wireless devices may be determined based on one or more designated routing parameters. In various embodiments, the designated routing parameters may be determined based on a received input. For example, an entity, such as a user, may specify an association between devices, such as a smartphone and a headset, and such an input may be received at a central wireless device and stored as routing information. In various embodiments, routing information may be received via an interface, such as a command interface. Accordingly, routing information may be received that identifies a mapping between devices, and such routing information may be used to identify a source device, a sink device, as well as translation operations that should be performed between them. As similarly discussed above, the routing information may be determined by an entity, such as a manufacturer or a user as well as one or more wireless standards.

Method 600 may perform operation 608 during which the mapping information may be stored in memory as a wireless device mapping. Accordingly, the mapping information may be stored in memory or a storage location that is accessible during relay operations. For example, when subsequent mapping and translation operations are performed, as similarly discussed above, the wireless device mapping may be retrieved and used to facilitate the mapping and translation operations.

Although the foregoing concepts have been described in some detail for purposes of clarity of understanding, it will be apparent that certain changes and modifications may be practiced within the scope of the appended claims. It should be noted that there are many alternative ways of implementing the processes, systems, and devices. Accordingly, the present examples are to be considered as illustrative and not restrictive.

What is claimed is:

1. A method comprising:
receiving an input via a first wireless connection at a wireless device, the input comprising a first data packet compatible with a first wireless protocol;
identifying a second wireless connection compatible with a second wireless protocol based on the received input;
generating, using a dual-mode controller of the wireless device, an output based, at least in part, on the received input and the second wireless protocol, the output comprising a second data packet compatible with the second wireless protocol; and
transmitting the output via the second wireless connection using the second wireless protocol.

2. The method of claim 1 further comprising:
determining that one or more translation operations should be performed on the first data packet.

3. The method of claim 2 further comprising:
decoding, using the dual-mode controller, the first data packet based on the first wireless protocol to generate decoded data; and
encoding, using the dual-mode controller, the decoded data based on the second wireless protocol to generate encoded data.

4. The method of claim 3 further comprising:
generating the second data packet based, at least in part, on the encoded data.

5. The method of claim 1 further comprising:
generating wireless connection data identifying a plurality of wireless connections; and
generating a wireless device mapping based, at least in part, on the wireless connection data, the wireless device mapping identifying associations between wireless devices underlying the plurality of wireless connections.

6. The method of claim 5, wherein the wireless device mapping comprises a plurality of wireless connection identifiers, a plurality of wireless device identifiers, and a plurality of wireless protocol identifiers.

7. The method of claim 5, wherein the wireless device mapping is generated based on routing parameters identifying wireless device associations.

8. The method of claim 7 further comprising:
receiving the routing parameters from a user.

9. The method of claim 1, wherein the first wireless protocol is a Bluetooth protocol, and wherein the second wireless protocol is a Bluetooth Low Energy protocol.

10. A system comprising:
a transceiver configured to send and receive data packets wirelessly;
one or more processors configured to implement a dual-mode controller, the dual-mode controller being configured to:
receive an input via a first wireless connection, the input comprising a first data packet compatible with a first wireless protocol;
identify a second wireless connection compatible with a second wireless protocol based on the received input; and
generate an output based, at least in part, on the received input and the second wireless protocol, the output comprising a second data packet compatible with the second wireless protocol.

11. The system of claim 10, wherein the dual-mode controller is further configured to:
decode the first data packet based on the first wireless protocol to generate decoded data; and
encode the decoded data based on the second wireless protocol to generate encoded data.

12. The system of claim 11, wherein the dual-mode controller is further configured to:
generate the second data packet based, at least in part, on the encoded data.

13. The system of claim 10, wherein the dual-mode controller is further configured to:
generate wireless connection data identifying a plurality of wireless connections; and
generate a wireless device mapping based, at least in part, on the wireless connection data, the wireless device mapping identifying associations between wireless devices underlying the plurality of wireless connections.

14. The system of claim 13, wherein the wireless device mapping comprises a plurality of wireless connection identifiers, a plurality of wireless device identifiers, and a plurality of wireless protocol identifiers.

15. The system of claim 10, wherein the first wireless protocol is a Bluetooth protocol, and wherein the second wireless protocol is a Bluetooth Low Energy protocol.

16. A device comprising:
one or more processors configured to implement a dual-mode controller, the dual-mode controller being configured to:
receive an input via a first wireless connection, the input comprising a first data packet compatible with a first wireless protocol;
identify a second wireless connection compatible with a second wireless protocol based on the received input; and
generate an output based, at least in part, on the received input and the second wireless protocol, the output comprising a second data packet compatible with the second wireless protocol.

17. The device of claim 16, wherein the dual-mode controller is further configured to:
decode the first data packet based on the first wireless protocol to generate decoded data; and
encode the decoded data based on the second wireless protocol to generate encoded data.

18. The device of claim 16, wherein the dual-mode controller is further configured to:
generate wireless connection data identifying a plurality of wireless connections; and
generate a wireless device mapping based, at least in part, on the wireless connection data, the wireless device mapping identifying associations between wireless devices underlying the plurality of wireless connections.

19. The device of claim 18, wherein the wireless device mapping comprises a plurality of wireless connection identifiers, a plurality of wireless device identifiers, and a plurality of wireless protocol identifiers.

20. The device of claim 16, wherein the first wireless protocol is a Bluetooth protocol, and wherein the second wireless protocol is a Bluetooth Low Energy protocol.
